(19) United States
(12) Patent Application Publication
(10) Pub. No.: US 2026/0017027 A1
(43) Pub. Date: Jan. 15, 2026

(54) APPLICATION GENERATION DEVICE, APPLICATION GENERATION METHOD, AND NON-TRANSITORY RECORDING MEDIUM

(71) Applicant: TOYOTA JIDOSHA KABUSHIKI KAISHA, Toyota-shi (JP)

(72) Inventor: Daisuke HASHIMOTO, Chofu-shi (JP)

(73) Assignee: TOYOTA JIDOSHA KABUSHIKI KAISHA, Toyota-shi (JP)

(21) Appl. No.: 19/192,653

(22) Filed: Apr. 29, 2025

(30) Foreign Application Priority Data
Jul. 11, 2024 (JP) 2024-111824

(51) Int. Cl. G06F 8/30; G06F 8/60; G06F 11/34; G06F 11/3668

(52) U.S. Cl. CPC G06F 8/30; G06F 8/60; G06F 11/3457; G06F 11/3688

(57) ABSTRACT

An application generation device generates a request for a machine learning model used for an application newly generated, based on a result of a dialogue with a user of the application, the dialogue being conducted by using a large language model, generates code of a simulator and simulation parameter used for learning of the machine learning model based on the request by using the large language model, build and generate runtime of the simulator, generates simulation data which is a set of input to the machine learning model and output from the machine learning model, by using the runtime of the simulator, and generates the machine learning model by using the simulation data as learning data.

### FIELD

The present disclosure relates to application generation device, application generation method, and non-transitory recording medium.

### BACKGROUND

PTL 1 (JP-A-2022-124878) discloses a technique in which when meteorological data is predicted by using a machine learning model, learning of the machine learning model is performed by using the data obtained by a simulation and the meteorological data is predicted.

In the technique described in PTL 1, the learning of the machine learning model is performed by using a conventional simulator (CFD (Computational Fluid Dynamics)). When an expensive existing simulator is used to perform the learning of the machine learning model as in the technique described in Patent Document 1, the cost is increased. In addition, when it is necessary to generate simulation data that greatly deviates from the existing specification of the simulator in order to perform the learning of the machine learning model, there is a possibility that the cost associated with change of the specification increases and it takes a long time to generate the simulation data.

### SUMMARY

In view of the above-described points, it is an object of the present disclosure to provide application generation device, application generation method, and non-transitory recording medium which can appropriately generate an application by using a machine learning model without the need to use an existing simulator.
(1) One aspect of the present disclosure is an application generation device including a processor configured to: generate a request for a machine learning model used for an application newly generated, based on a result of a dialogue with a user of the application, the dialogue being conducted by using a large language model; generate code of a simulator and simulation parameter used for learning of the machine learning model based on the request by using the large language model, build and generate runtime of the simulator; generate simulation data which is a set of input to the machine learning model and output from the machine learning model, by using the runtime of the simulator; and generate the machine learning model by using the simulation data as learning data.
(2) In the application generation device of the aspect (1), the processor may be configured to: perform a test of the machine learning model by using the request; and deploy the machine learning model passing the test to the application.
(3) In the application generation device of the aspect (1) or (2), the processor may be configured to feed back a user experience, which is a result of the test by the user of the application to which the machine learning model is deployed, to generation of the request and generation of the code by using the large language model.
(4) Another aspect of the present disclosure is an application generation method including: generating a request for a machine learning model used for an application newly generated, based on a result of a dialogue with a user of the application, the dialogue being conducted by using a large language model; generating code of a simulator and simulation parameter used for learning of the machine learning model based on the request by using the large language model, build and generate runtime of the simulator; generating simulation data which is a set of input to the machine learning model and output from the machine learning model, by using the runtime of the simulator; and generating the machine learning model by using the simulation data as learning data.
(5) Another aspect of the present disclosure is a non-transitory recording medium having recorded thereon a computer program for causing a processor to perform a process including: generating a request for a machine learning model used for an application newly generated, based on a result of a dialogue with a user of the application, the dialogue being conducted by using a large language model; generating code of a simulator and simulation parameter used for learning of the machine learning model based on the request by using the large language model, build and generate runtime of the simulator; generating simulation data which is a set of input to the machine learning model and output from the machine learning model, by using the runtime of the simulator; and generating the machine learning model by using the simulation data as learning data.

According to the present disclosure, it is possible to appropriately generate an application by using a machine learning model without the need to use an existing simulator.

### BRIEF DESCRIPTION OF DRAWINGS

FIG. 1 is a view showing an example of an application generation device 1 of a first embodiment.

FIG. 2 is a view showing an example of an application generation system SY to which the application generation device 1 shown in FIG. 1 is applied.

FIG. 3 is a flowchart for explaining an example of a process performed by a large language model (LLM) in the application generation system SY shown in FIG. 2.

FIG. 4 is a flowchart for explaining an example of a process performed by a processor 13 of the application generation device 1 of the first embodiment.

### DESCRIPTION OF EMBODIMENTS

Below, referring to the drawings, embodiments of application generation device, application generation method, and non-transitory recording medium of the present disclosure will be explained.

### First Embodiment

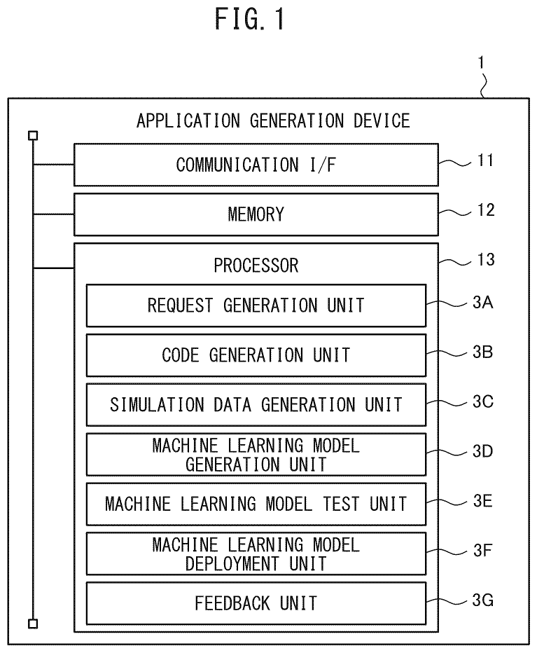

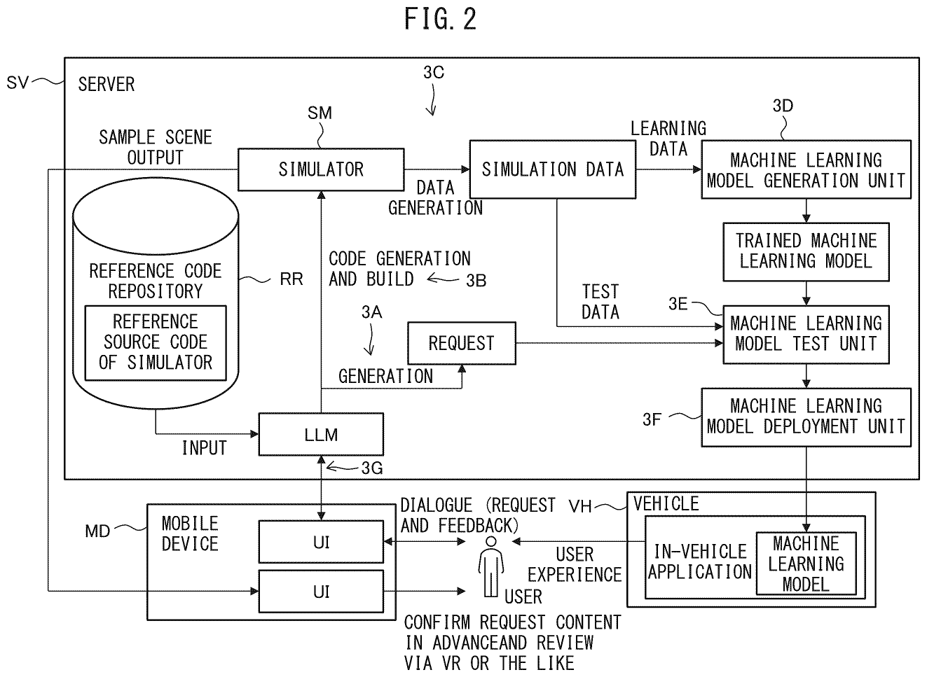

FIG. 1 is a view showing an example of an application generation device 1 of a first embodiment. FIG. 2 is a view showing an example of an application generation system SY to which the application generation device 1 shown in FIG. 1 is applied.

In the example shown in FIG. 1 and FIG. 2, a server SV (see FIG. 2), a vehicle VH (see FIG. 2), and a mobile device MD (see FIG. 2) are included in the application generation system SY (see FIG. 2). The application generation device 1 (see FIG. 1) of the first embodiment is incorporated into the server SV. The application generation device 1 generates an application (in-vehicle application) which is used by a user (user of the vehicle VH, user of the application) in the vehicle VH.

In the example shown in FIG. 1, the application generation device 1 is configured by a microcomputer including a communication interface 11, a memory 12, and a processor 13. The communication interface 11 includes an interface circuit for connecting the application generation device 1 to other components in the server SV (for example, a simulator SM (see FIG. 2), a reference code repository RR (see FIG. 2), etc.), the vehicle VH on which the user rides, the mobile device MD used by the user riding in the vehicle VH, and the like. The memory 12 stores program used in a process performed by the processor 13 and various data. The processor 13 has a function as a request generation unit 3A, a function as a code generation unit 3B, a function as a simulation data generation unit 3C, a function as a machine learning model generation unit 3D, a function as a machine learning model test unit 3E, a function as a machine learning model deployment unit 3F, and a function as a feedback unit 3G.

The machine learning model generation unit 3D generates a machine learning model used for the application (application used by the user) newly generated by the application generation device 1.

The request generation unit 3A generates a request for the machine learning model generated by the machine learning model generation unit 3D based on a result of a dialogue with the user, the dialogue is conducted by using a large language model (LLM). In the example shown in FIG. 2, the large language model interacts with the user via a user interface (UI) of the mobile device MD. The request generation unit 3A acquires the result of the dialogue conducted by using the large language model with the user and generates the request for the machine learning model based on the result of the dialogue.

In the example shown in FIG. 1, the code generation unit 3B generate code of the simulator SM (see FIG. 2) and simulation parameter used for learning of the machine learning model based on the request generated by the request generation unit 3A, by using the large language model.

In the example shown in FIG. 2, the reference source code of the simulator SM stored in the reference code repository RR is inputted into the large language model in order for the large language model to generate the code of the simulator SM and the simulation parameter.

In the example shown in FIG. 2, the simulator SM is a rule-based simulator. In another example, the simulator SM may be a simulator other than the rule-based simulator.

In the example shown in FIG. 2, the code of the simulator SM is a C++ (C plus plus) source code. In another example, the code of the simulator SM may be a code other than the C++ source code.

In the example shown in FIG. 1, the code generation unit 3B builds and generates runtime of the simulator SM.

The simulation data generation unit 3C generates simulation data which is a set of input to the machine learning model generated by the machine learning model generation unit 3D and output (expected output) from the machine learning model by using the runtime of the simulator SM generated by the code generation unit 3B.

In the example shown in FIG. 2, the simulation data generated by the simulation data generation unit 3C is an image (for example, image which corresponds to an image captured by a camera mounted on the vehicle VH) which is input to the machine learning model. That is, in this example, the input to the machine learning model constituting a part of the simulation data is the image (image generated (simulated) by the simulator SM).

In another example, the simulation data generated by the simulation data generation unit 3C may be sensor data (for example, sensor data which corresponds to data of a sensor mounted on the vehicle VH) which is input to the machine learning model. That is, in this example, the input to the machine learning model constituting the part of the simulation data is the sensor data (sensor data generated (simulated) by the simulator SM).

In the example shown in FIG. 2, the simulation data generated by the simulation data generation unit 3C is the inference result of the machine learning model outputted from the machine learning model. That is, in this example, the output (expected output) from the machine learning model constituting another part of the simulation data is the inference result of the machine learning model.

In the example shown in FIG. 1, the machine learning model generation unit 3D generates the machine learning model by using the simulation data (set of the input to the machine learning model and the output from the machine learning model) generated by the simulation data generation unit 3C as the learning data.

In the example shown in FIG. 2, the machine learning model generation unit 3D generates the machine learning model by performing an architecture search. Specifically, the machine learning model generation unit 3D generates a learned machine learning model (see FIG. 2) by performing the learning of the machine learning model.

In the example shown in FIG. 1, the machine learning model test unit 3E performs a test of the machine learning model generated by the machine learning model generation unit 3D by using the request generated by the request generation unit 3A.

In the example shown in FIG. 2, the machine learning model test unit 3E performs the test of the machine learning model generated by the machine learning model generation unit 3D by using the request generated by the request generation unit 3A and the simulation data (test data) generated by the simulation data generation section 3C.

In the example shown in FIG. 1, the machine learning model deployment unit 3F deploys the machine learning model passing the test performed by the machine learning model test unit 3E to the application (in-vehicle application) utilized by the user.

The feedback unit 3G feeds back a user experience, which is a result of test by the user of the application to which the machine learning model is deployed, to the request generation unit 3A and the code generation unit 3B by using the large language model.

In the example shown in FIG. 2, the large language model acquires the result of the test (user experience) of the in-vehicle application from the user through the user interface of the mobile device MD and sends it to the request generation unit 3A and the code generation unit 3B.

Also, in the example shown in FIG. 2, the simulator SM outputs a sample scene and sends it to the mobile device MD. The user can confirm the sample scene sent from the simulator SM to the mobile device MD via the user interface (e.g., VR (Virtual Reality) or the like). That is, the user can confirm and review the sample scene outputted by the simulator SM in advance prior to the application being actually generated by the application generation device 1.

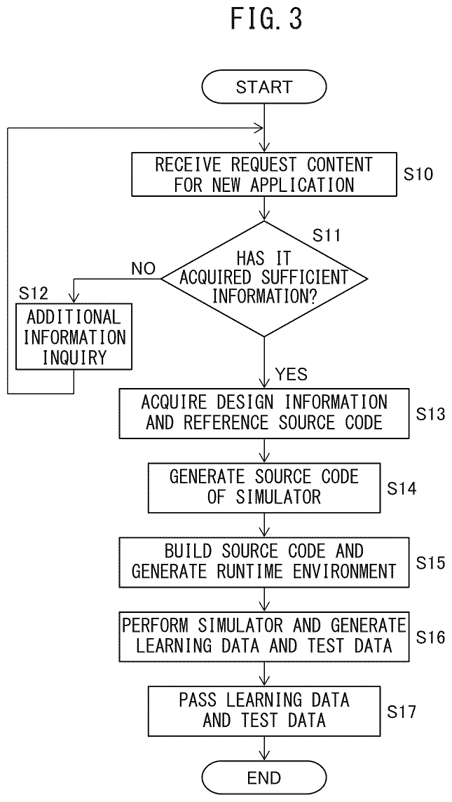

FIG. 3 is a flowchart for explaining an example of a process performed by the large language model in the application generation system SY shown in FIG. 2.

In the example shown in FIG. 3, at step S10, the large language model receives a request content for the application newly generated by the application generation device 1 from the user (user interface used by the user).

At step S11, the large language model determines whether it has acquired sufficient information from the user. When NO, it proceeds to step S12; when YES, it proceeds to step S13.

At step S12, the large language model makes an additional information inquiry to the user (i.e., requests the additional information from the user) and returns to step S10.

At step S13, the large language model acquires the design information and the reference source code of the simulator SM serving as the reference from the reference code repository RR.

At step S14, the large language model generates the source code (C++ source code) of the simulator SM to generate the data representing the request of the user based on the information acquired from the reference code repository RR.

At step S15, the large language model builds the source code of the simulator SM and generates a runtime environment (e.g., docker container, etc.) in which simulator SM is performed.

At step S16, the large language model performs the simulator SM and causes the simulator SM to generate the learning data and the test data.

At step S17, the large language model causes the simulator SM to pass the generated learning data to the machine learning model generation unit 3D (model trainer), and the generated test data to the machine learning model test unit 3E (model tester).

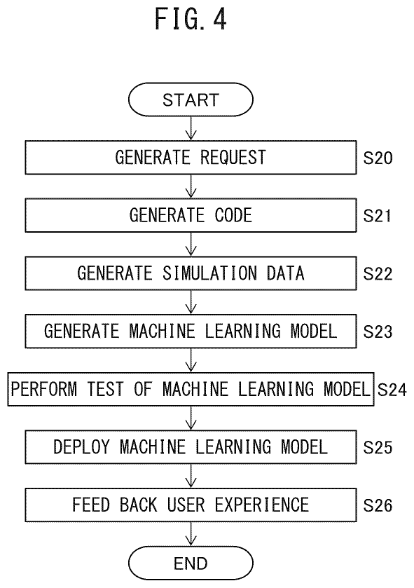

FIG. 4 is a flowchart for explaining an example of a process performed by the processor 13 of the application generation device 1 of the first embodiment.

In the example shown in FIG. 4, at step S20, the request generation unit 3A generates the request for the machine learning model used for the application newly generated based on the result of the dialogue with the user, the dialogue is conducted by using the large language model.

At step S21, the code generation unit 3B generates the code of the simulator SM and the simulation parameter used for the learning of the machine learning model based on the request generated at step S20 by using the large language model, builds and generates the runtime of the simulator SM.

At step S22, the simulation data generation unit 3C generates the simulation data which is the set of input to the machine learning model and output from the machine learning model, by using the runtime of the simulator SM generated at step S21.

At step S23, the machine learning model generation unit 3D generates the machine learning model by using the simulation data generated at step S22 as the learning data.

At step S24, the machine learning model test unit 3E performs the test of the machine learning model generated at step S23 by using the request generated at step S20.

At step S25, the machine learning model deployment unit 3F deploys the machine learning model passing the test performed at step S24 to the application (in-vehicle application) utilized by the user.

At step S26, the feedback unit 3G feeds back the user experience, which is the result of the test by the user of the application to which the machine learning model is deployed, to the request generation unit 3A and the code generation unit 3B by using the large language model.

In the application generation system SY to which the application generation device 1 of the first embodiment is applied, as described above, the result (user experience) of test by the user of the application to which the machine learning model is deployed is fed back to the request generation unit 3A and the code generation unit 3B by the feedback unit 3G. Therefore, agile tries and errors can be easily repeated.

Further, in the application generation system SY to which the application generation device 1 of the first embodiment is applied, as described above, the code generation unit 3B generates the code of the simulator SM and the simulation parameter used for the learning of the machine learning model based on the request generated by the request generation unit 3A by using the large language model. Therefore, the simulation data which greatly deviate from the specification of the existing simulator (not shown) can also be easily generated.

Furthermore, in the application generation system SY to which the application generation device 1 of the first embodiment is applied, as described above, the simulation parameter and the simulator SM itself (for example, the C++ source code of the simulator SM) are automatically generated by the code generation unit 3B based on the dialogue with the user. Therefore, the simulation parameter and the simulator SM itself can be inexpensively and easily disposable. In addition, the machine learning model is generated by the machine learning model generation unit 3D by using the simulation data generated by the simulation data generation unit 3C. Therefore, agile tries and errors of the novel idea becomes possible.

Further, in the application generation system SY to which the application generation device 1 of the first embodiment is applied, as described above, since the simulator SM itself is automatically generated by the code generation unit 3B based on the dialogue with the user, automatic generation of data for easily experimenting with a new idea can be performed at a low cost and agile without being subject to restrictions on the specifications of the existing products of the simulator, money and time costs due to specification changes, and restrictions on licensing costs.

In the application generation system SY to which the application generation device 1 of the first embodiment is applied, the logic itself of the simulator is not used in the vehicle application. Therefore, it is possible to suppress the possibility that the logic of the simulator becomes complicated and high cost (e.g., computational cost, high memory cost) as the requirements become complicated. In the application generation system SY to which the application generation device 1 of the first embodiment is applied, as described above, since the machine learning model is learned by using the output of the simulator SM to be deployed to the in-vehicle application, a secondary effect such that the machine learning model compresses the logic of the simulator SM can be obtained, and the hardware resource burden of the in-vehicle ECU (Electronic Control Unit) can be reduced more than when the complex logic is directly mounted on the vehicle VH.

### [First Use Case]

In a first use case of the application generation system SY of the first embodiment, when the user travels to the Yellowstone National Park in the vehicle VH, the user asks the large language model that “I want to see the bear with the naked eye. If you find the bear, please notify,” the code generation unit 3B automatically generates the simulator SM that generates simulation data in which the bear appears around the roads of the trip in the Yellowstone National Park. The machine learning model generation unit 3D generates (learns) the machine learning model for detecting the bear by using the simulation data as the learning data. The machine learning model test unit 3E performs the test of the machine learning model, and the machine learning model deployment unit 3F deploys the machine learning model passing the test to the in-vehicle application which detects and notifies the bear. The in-vehicle application is utilized by the user on the vehicle VH.

### [Second Use Case]

In a second use case of the application generation system SY of the first embodiment, when the user drives the vehicle VH on the mountain road after rain, and when the user consults the large language model that “There is a fear of a cliff collapse after a long rain. Since there is a possibility of a landslide, notify or propose a detour route if more than usual rock fall is detected on the ground.”, the application generation device 1 generates the in-vehicle application which detects the rock fall and makes the notification or the detour route proposal. The in-vehicle application is utilized by the user on the vehicle VH.

### [Third Use Case]

In a third use case of the application generation system SY of the first embodiment, when the user consults the large language model that “When a friend is picked up by the vehicle VH, it is anxious whether a friend can be detected in the crowd and picked up smoothly from the crowd.” and when the aspect of the friend or the feature of the day are input to the large language model as prior information, the application generation device 1 automatically generates the in-vehicle application which immediately detects and tracks the friend. The in-vehicle application is utilized by the user on the vehicle VH.

### Second Embodiment

The application generation device 1 of a second embodiment is configured similarly to the application generation device 1 of the first embodiment described above except for the points described below.

As described above, the application generation device 1 of the first embodiment generates the in-vehicle application.

On the other hand, the application generation device 1 of the second embodiment generates the non-vehicle application. The non-vehicle application generated by the application generation device 1 of the second embodiment is incorporated into the mobile device MD (see FIG. 2) or the like used, for example, by the user.

### Third Embodiment

The application generation device 1 of a third embodiment is configured similarly to the application generation device 1 of the first embodiment described above except for the points described below.

The application generation system SY to which the application generating apparatus 1 of the third embodiment is applied includes the vehicle VH (see FIG. 2) and the mobile device MD (see FIG. 2), and does not include the server SV (see FIG. 2). The application generation device 1 of the third embodiment is incorporated in the vehicle VH. The application generation device 1 of the third embodiment generates the application (in-vehicle application) that is used by the user (user of the vehicle VH, user of the application) in the vehicle VH.

In an example of the application generation system SY to which the application generation device 1 of the third embodiment is applied, the communication interface 11 of the application generation device 1 has the interface circuit for connecting the application generation device 1 to other components in the vehicle VH (for example, the simulator SM, the reference code repository RR, or the like), the mobile device MD used by the user riding in the vehicle VH, and the like.

In another example, the reference code repository RR may be located outside the vehicle VH (e.g., server or the like).

As described above, although the embodiments of the application generation device, the application generation method, and the non-transitory recording medium of the present disclosure have been described with reference to the drawings, the application generation device, the application generation method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the application generation device 1 has been described as software process performed by executing the program, but the process performed in the application generation device 1 may be process performed by hardware. Alternatively, the process performed by the application generation device 1 may be a combination of both software and hardware. Further, the program (program for realizing the function of the processor 13 of the application generation device 1) stored in the memory 12 of the application generation device 1 may be recorded in a computer-readable storage medium (non-transitory recording medium) such as, semiconductor memory, magnetic recording medium, optical recording medium, or the like for providing, distribution or the like.

1. An application generation device comprising a processor configured to:
generate a request for a machine learning model used for an application newly generated, based on a result of a dialogue with a user of the application, the dialogue being conducted by using a large language model;
generate code of a simulator and simulation parameter used for learning of the machine learning model based on the request by using the large language model, build and generate runtime of the simulator;
generate simulation data which is a set of input to the machine learning model and output from the machine learning model, by using the runtime of the simulator; and
generate the machine learning model by using the simulation data as learning data.

2. The application generation device according to claim 1, wherein the processor is configured to:
perform a test of the machine learning model by using the request; and
deploy the machine learning model passing the test to the application.

3. The application generation device according to claim 2, wherein the processor is configured to feed back a user experience, which is a result of the test by the user of the application to which the machine learning model is deployed, to generation of the request and generation of the code by using the large language model.

4. An application generation method comprising:
generating a request for a machine learning model used for an application newly generated, based on a result of a dialogue with a user of the application, the dialogue being conducted by using a large language model;
generating code of a simulator and simulation parameter used for learning of the machine learning model based on the request by using the large language model, build and generate runtime of the simulator;
generating simulation data which is a set of input to the machine learning model and output from the machine learning model, by using the runtime of the simulator; and
generating the machine learning model by using the simulation data as learning data.

5. A non-transitory recording medium having recorded thereon a computer program for causing a processor to perform a process comprising:
generating a request for a machine learning model used for an application newly generated, based on a result of a dialogue with a user of the application, the dialogue being conducted by using a large language model;
generating code of a simulator and simulation parameter used for learning of the machine learning model based on the request by using the large language model, build and generate runtime of the simulator;
generating simulation data which is a set of input to the machine learning model and output from the machine learning model, by using the runtime of the simulator; and
generating the machine learning model by using the simulation data as learning data.
